(19) United States
(12) Patent Application Publication
(10) Pub. No.: US 2024/0209948 A1
(43) Pub. Date: Jun. 27, 2024

(54) FLOW CONTROL DEVICE AND VALVE

(71) Applicants: Paul Errigo, Monmouth Beach, NJ (US); Al Dorso, Little Falls, NJ (US)

(72) Inventors: Paul Errigo, Monmouth Beach, NJ (US); Al Dorso, Little Falls, NJ (US)

(21) Appl. No.: 18/169,156

(22) Filed: Feb. 14, 2023

Related U.S. Application Data
(60) Provisional application No. 63/311,406, filed on Feb. 17, 2022.

(51) Int. Cl. F16K 3/08; F16K 3/30; F16K 31/60

(52) U.S. Cl. CPC F16K 3/08; F16K 3/30; F16K 31/60

(57) ABSTRACT

A flow control device comprises a first component having a plurality of plates with open spaces, and a second component also having a plurality of plates with open spaces. The first component and the second component are movable relative to each other between a first position wherein the plates and the open spaces of the first and second components substantially correspond with each other to permit fluid flow and a second position wherein the plates of the first component substantially overlie the open spaces of the second component to reduce or prevent fluid flow.

### CROSS REFERENCE TO RELATED APPLICATIONS

This application claims the benefit of United States Provisional Patent Application No. 63/311,406 filed Feb. 17, 2022, the contents of which are incorporated herein by reference in their entirety.

### FIELD AND BACKGROUND OF THE INVENTION

This invention relates to a flow control device and valve mechanism. The invention further relates to such a flow control device which may be located in a fluid stream flow pathway, and by adjustment of the flow control device modulates the volume or flow rate of the fluid in the fluid stream pathway. The flow rate may be varied between no or minimal flow, and near full or full flow so that the flow control valve does not substantially affect the flow rate which would otherwise occur in the fluid stream pathway.

### SUMMARY OF THE INVENTION

In one aspect, the invention is for a flow control valve or device for modulating fluid flow, and comprises a first component having a plurality of vanes or plates or blades with open spaces therebetween, and a second component having a plurality of vanes or plates or blades with open spaces therebetween, wherein the first component and the second component are movable relative to each other between a first position wherein the vanes and the open spaces of the first and second components substantially correspond with each other to permit fluid flow and a second position wherein the vanes of the first component substantially overlie the open spaces of the second component to reduce or prevent fluid flow.

The movement between the first and the second components may be effected incrementally so that the flow rate can be finely adjusted according to the needs and context of the location and use of the flow control device or valve of the present invention. Thus, the open spaces of the first component can be partially covered by the vanes of the second component to achieve a selected flow rate which is needed in a given situation.

In one form of the invention, the flow control valve has the first component which comprises a housing and which incorporates the vanes or plates or blades, and the second component comprises a movable vane component which is pivotally or rotatably or otherwise movably connected to the housing such that the respective vanes and open spaces may positioned as needed by moving the movable vane component within the housing of the first component.

Preferably, both the first component and the second component are at least in part of circular shape, each having a center connection point and pivot point, by means of which the first component is connected to the second component, and an outer circumference. In this aspect of the invention, the vanes of both the first component and the second component may be radial in nature, extending from at or near the center connection point to at or near the outer circumference of the first or second component respectively.

The vanes may taper from a narrow point or dimension near the center, and widen as they radiate out toward the outer circumferences.

Preferably, the second component has a handle which extends to the outside of the housing, or to some other accessible point, to permit rotation of the second component in incremental distances so that flow control valve of the invention can be easily appropriately adjusted and modulated, even while in operation. There may be a lock or other device for releasably fixing the handle at a specific selected point to prevent movement during operation. Operation of the valve may be manual, as noted above, or it may be performed by a motor or other device. Adjustment of the flow control valve may be monitored and modulated on a real time basis, and this may be based on strategically placed sensors in the flow path or elsewhere, so that that the device can have a set or adjustable flow rate which can change as the operation continues, or in response to, for example, pressure and temperature variations or other criteria such as load demands or storage capacity of downline devices or apparatus, all or some of which may affect the flow rate of the fluid through the device.

Preferably, the flow control valve of the invention is used for adjusting the flow rate of a liquid, such as water, but the invention is not limited to this material and any type of fluid, whether liquid or gas or a combination thereof, may be passed through the flow control valve to modulate and control its flow rate.

According to one aspect of the invention, there is provided a flow control device comprising: a housing having an inlet and an outlet; an inlet conduit connected to the inlet of the housing and through which fluid flows; an outlet conduit connected to the outlet of the housing and through which fluid flows; a fixed plate in the housing, the fixed plate having alternating vanes and spaces between the vanes; a movable plate in the housing, the movable plate having alternating vanes and spaces between the vanes; wherein the movable plate is movable relative to the fixed plate between a first position where the vanes and the spaces of the movable plate substantially correspond with the vanes and open spaces of the fixed plate to permit fluid flow, and a second position where the vanes and spaces of the movable plate substantially overlie the vanes and spaces of the fixed plate to reduce or prevent fluid flow.

Preferably, the flow control device further comprises a handle formed on the movable plate, the handle extending to the outside of the housing so that the position of the movable plate can be adjusted by movement of the handle to vary flow rate.

The fixed plate may be circular with outwardly radiating vanes increasing in width, and the movable plate may be circular with outwardly radiating vanes increasing in width.

According to a further aspect of the invention, there is provided a method of controlling flow rate through a valve comprising: providing a housing having an inlet and an outlet; connecting an inlet conduit at the inlet of the housing and through which fluid flows; connecting an outlet conduit to the outlet of the housing and through which fluid flows; locating a fixed plate in the housing, the fixed plate having alternating vanes and spaces between the vanes; locating a movable plate in the housing, the movable plate having alternating vanes and spaces between the vanes; moving the movable plate relative to the fixed plate between a first position where the vanes and the spaces of the movable plate substantially correspond with the vanes and open spaces of the fixed plate to permit fluid flow, and a second position where the vanes and spaces of the movable plate substantially overlie the vanes and spaces of the fixed plate to reduce or prevent fluid flow.

### BRIEF DESCRIPTION OF THE DRAWINGS

In the drawings:

FIG. 1A and FIG. 1B illustrate a front view and a side view respectively of a housing of a flow control valve in accordance with one aspect of the invention;

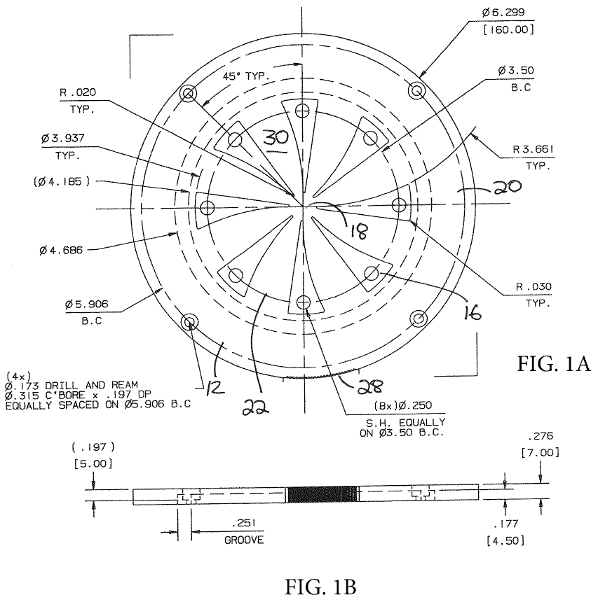

FIG. 2A and FIG. 2B and FIG. 2C illustrate a rear view and a side view and a cross section respectively of a housing of the flow control valve as shown in FIG. 1A of the drawings;

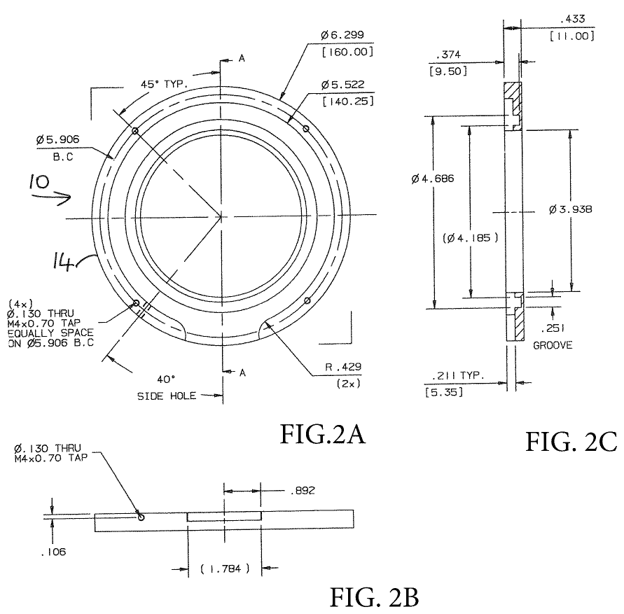

FIG. 3A and FIG. 3B illustrate a front view and a side view respectively of a flow control valve in accordance with one aspect of the invention, which may be used with the housing as shown in FIG. 1A of the drawings;

FIG. 4A and FIG. 4B illustrate a front view and side view respectively of a further feature of the flow control valve in the form of a wrench for use in accordance with a further aspect of the invention;

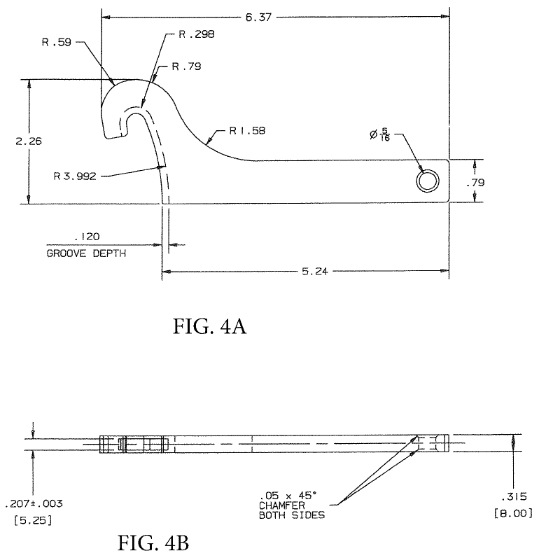

FIG. 5 is a perspective view of a housing part of the flow control valve of the invention;

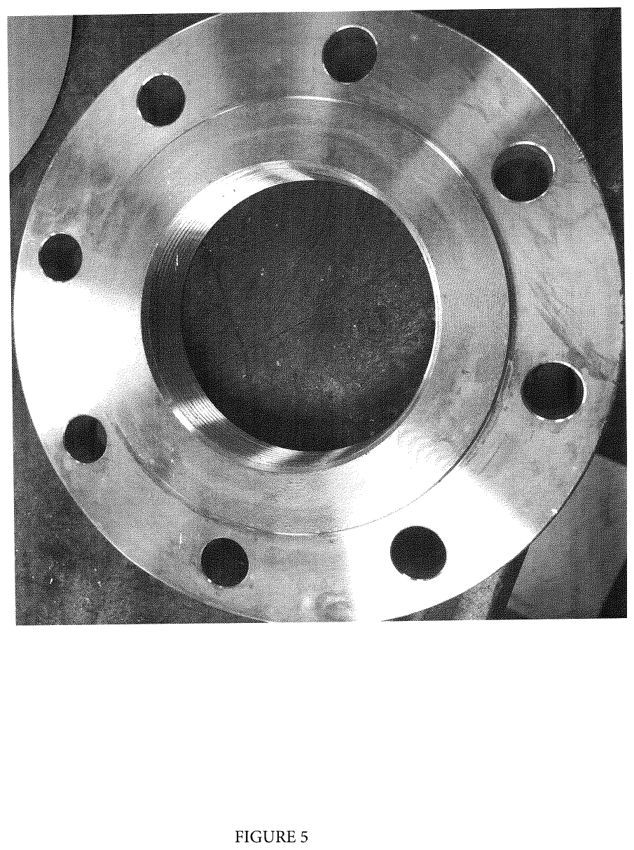

FIG. 6 is a top view of the flow control valve in accordance with an aspect of the invention;

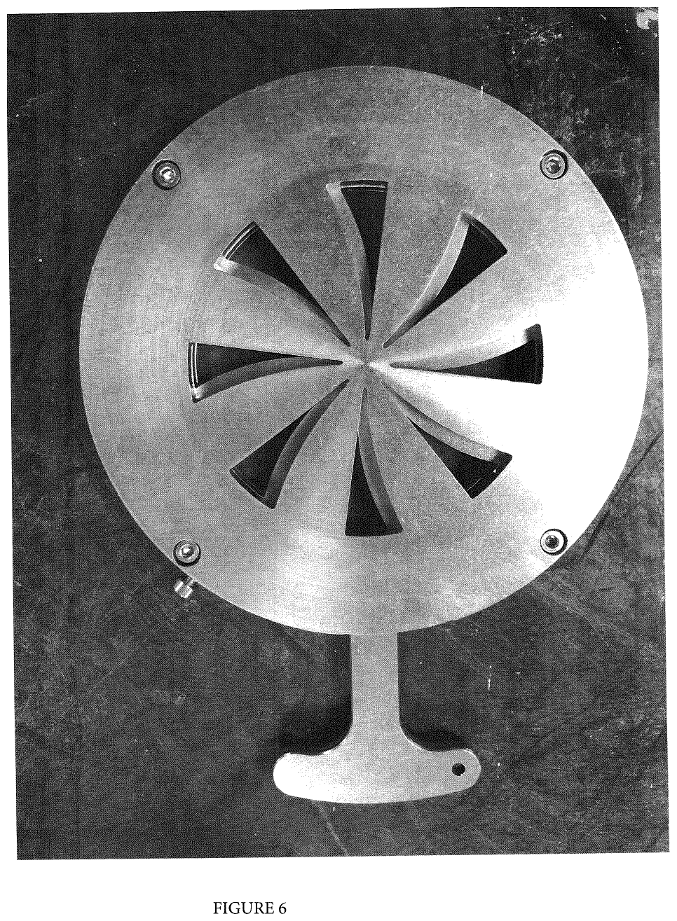

FIG. 7 is a top perspective view of the flow control valve in accordance with the invention;

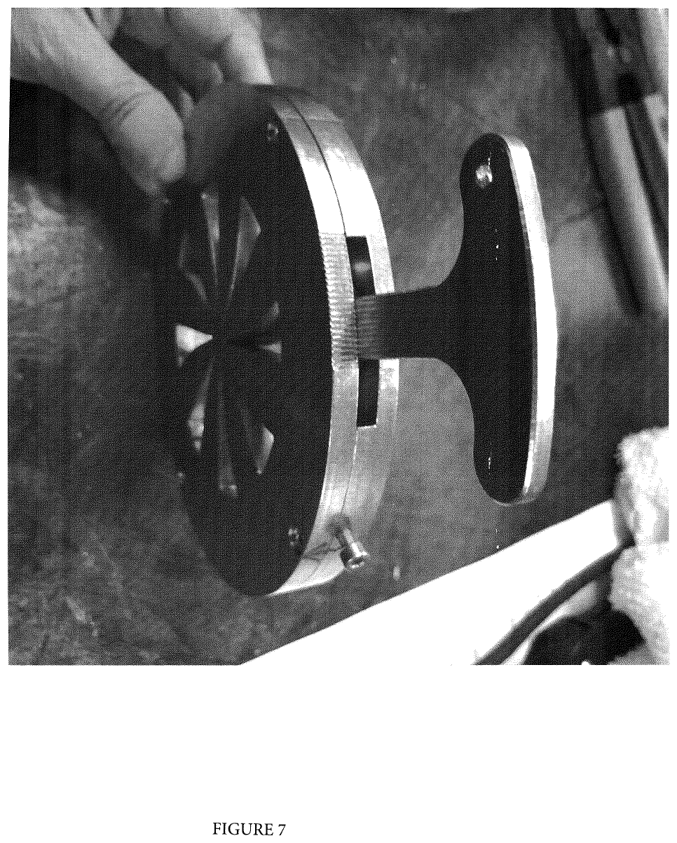

FIG. 8 is a further perspective view of the flow control valve in accordance with the invention;

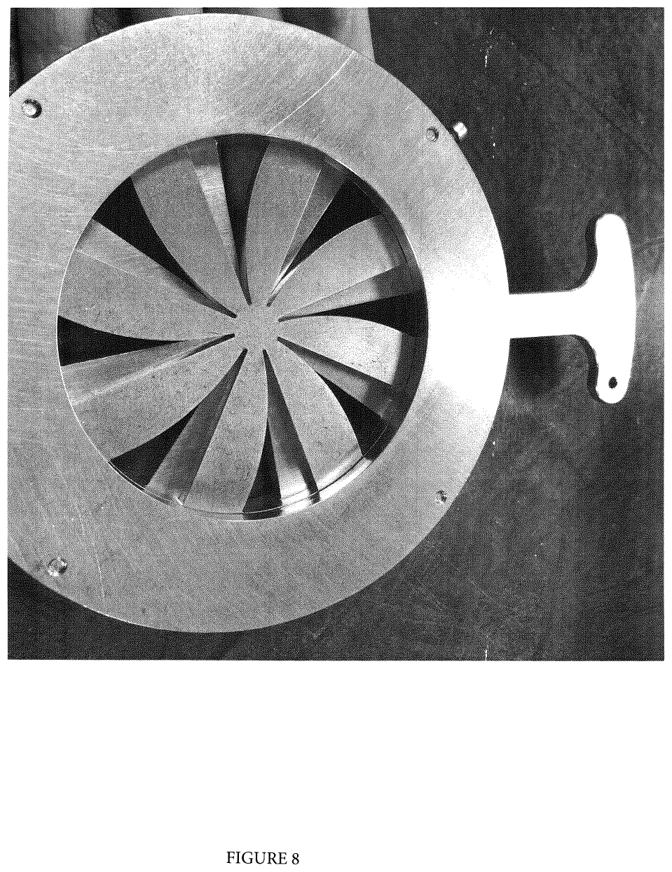

FIG. 9 is a further top perspective view of the flow control valve in accordance with the invention;

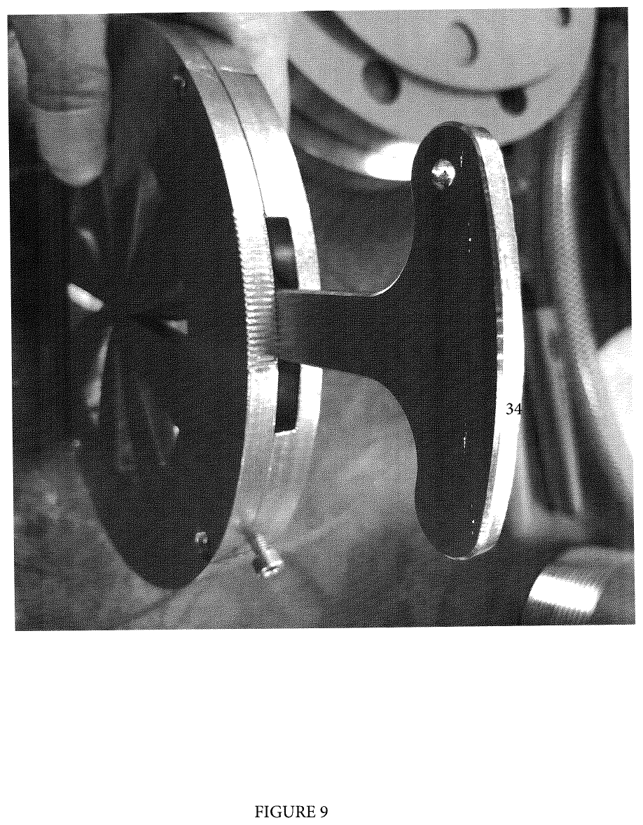

FIG. 10 is a top view of the flow control valve of the invention shown in a bolted down configuration, with the vanes and open spaces illustrated;

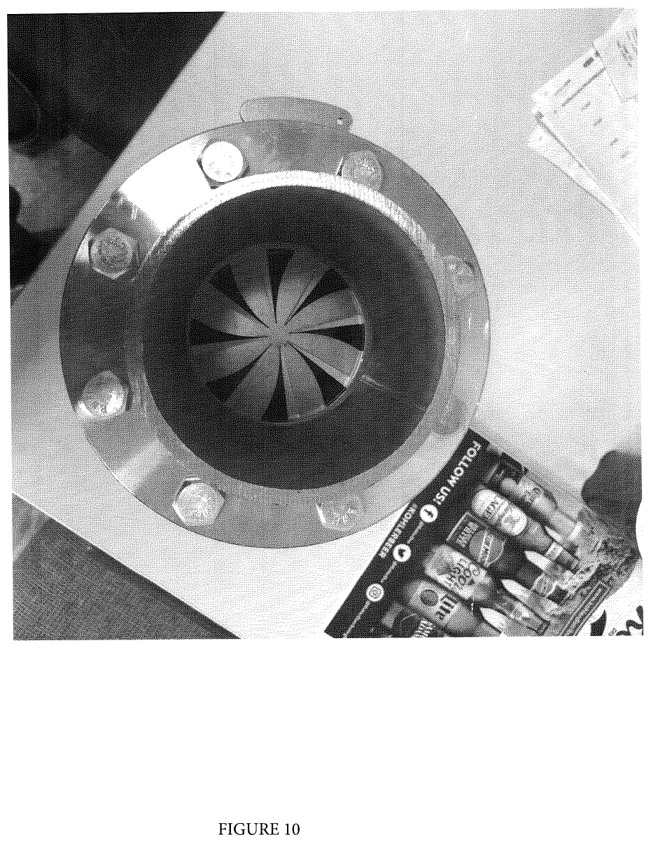

FIG. 11 illustrates a flow control valve of the invention when installed in a conduit which conveys a fluid;

FIG. 12 is a further view of the flow control valve as seen in FIG. 10 of the drawings, showing the vanes and open spaces; and

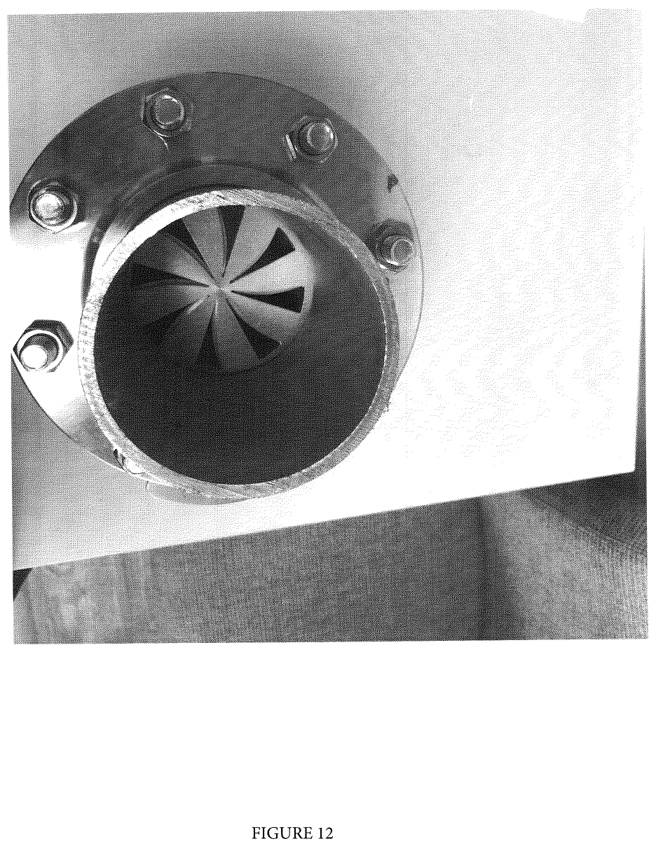

FIG. 13 is a detail view of the flow control valve installed in a fluid conduit path, and showing the handle for adjusting the valve to modulate the flow rate of fluid able to pass through the valve.

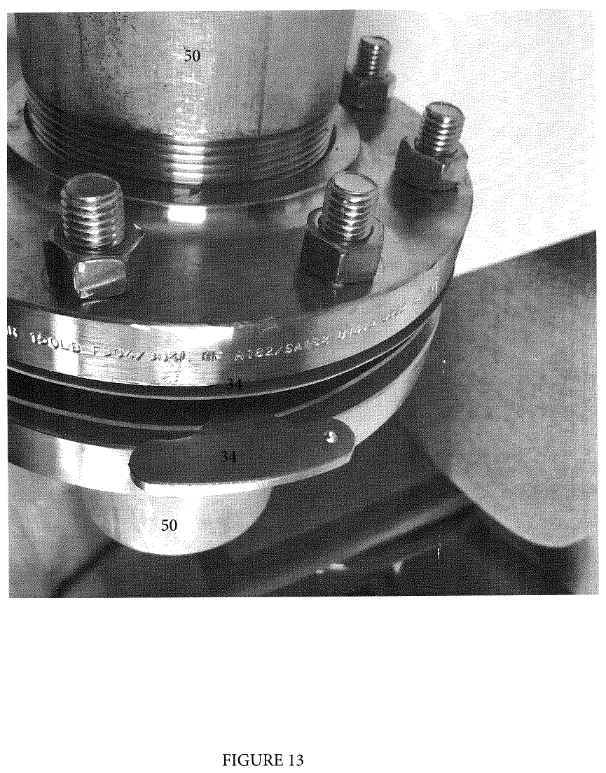

### DETAILED DESCRIPTION OF THE INVENTION

Reference is now made to accompanying drawings, which show some but not all of the possible embodiments of the invention. The drawings show a valve or housing 10 comprised of a front housing section 12 and a rear housing section 14, the two of which are bolted together to form the valve or housing 10. The front housing section 12 has a plurality of radially configured vanes or blades or plates 16 extending from the center 18 of the front housing section 12 to the circumferential ring 20. The vanes or plates 16 define therebetween a series of space openings 22.

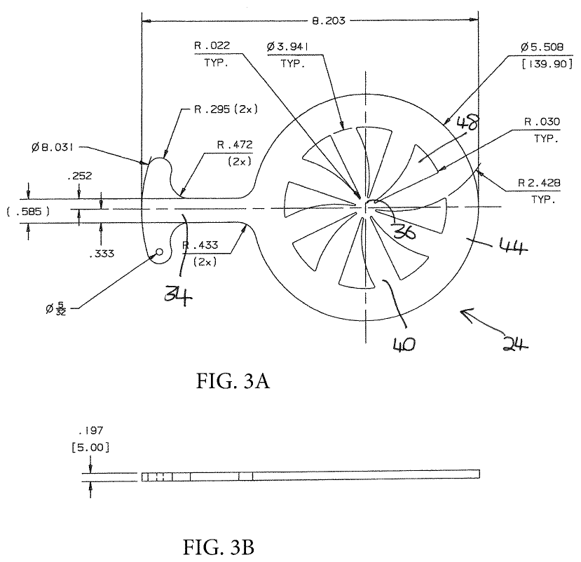

The front housing section 12 and rear housing section 14 are connected, such as by bolts, so as to create a space 30 in which is located a movable flow control component 24 (see for example FIG. 3A of the drawings). Further, the front housing section 12 has a handle opening 28 along the circumferential ring 20.

The movable flow control component 24, seen clearly in FIG. 3A of the drawings, is accommodated in the space 30, and has a handle 34, which may be T-shaped, and which extends outwardly from the space 30 through the handle opening 28 formed in the valve or housing 10. The movable flow control component 24 rotates about its center 36 which operates as a pivot point. The movable flow control component 24 also has a plurality of radially outwardly projecting vanes 40 originating near the center 36 and extending to the outer ring 44. The vanes 40 are spaced from each other and may be shaped in a similar manner to the vanes 16 of the front housing section 12, although it is not essential that this be the case. They may of different shapes and sizes and number, depending on the nature of the application for which the device may be used.

The movable flow control component 24 has space openings 48 defined between each of the vanes 40. The flow control component 24 is able to rotate in the space 30 of the front housing section 12, and the rotation thereof is achieved by moving the handle 34 which is T-shaped and extends out through the handle opening 28 for easy access. The size of the handle opening 28 determines the extent to which the flow control component 24 can move, since the handle 34 will butt up against the edge of the handle opening 28 to place a limitation on its movement. Nevertheless, the extent of movement is sufficient to allow the movable flow control component 24 to move so as to substantially block or substantially unblock the fluid flow path defined by the housing, and modulate or control the valve 10 flow rate and the fluid passing therethrough, as will be described in further detail below.

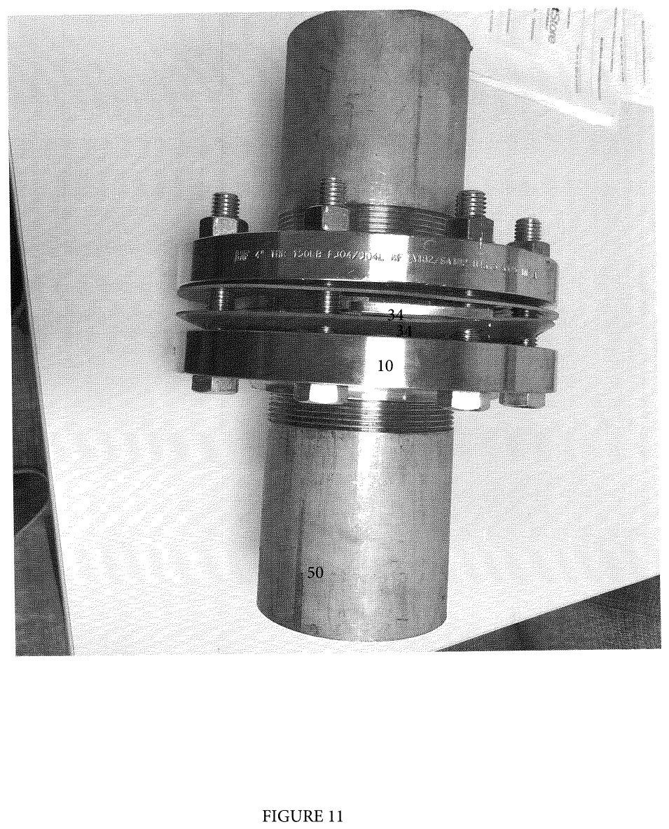

In use, the valve 10 is placed sealingly in the path of a conduit 50 for a flowing fluid, as seen for example in FIG. 11 of the drawings. With the valve 10 in place, and the handle 34 extending therefrom, the flow rate of the fluid in the conduit 50 can be easily adjusted by suitably rotating the handle 34. By rotating the handle 34, the vanes 16 of the front housing section 12 will come into correspondence with the vanes 40 of the movable control component 24, and the same will be true of the space openings 22 on the front housing section 12 and the space openings 48 of the moveable flow control component 24. In this configuration, the fluid in the conduit 50 will be able to flow through the valve 10 at maximum rate which can be achieved with the valve 10.

When the handle 34 is rotated, the vanes 16 of the front housing section 12 move to cover part of the space openings 48 of the moveable flow control component 24, and the vanes 40 of the moveable flow control component move to cover a part of the space openings 22 of the front housing section 12. Incremental movement of the handle 34 and concomitant rotation of the moveable flow control component 24 closes the space openings 22 and 48 more and more, so that flow rate can thereby be adjusted. Eventually, the rotation of the movable flow control component 24 causes all of the space opening 22 and 48 to be substantially closed or near closed by the relative positions of the respective vanes 40 and 16, so that the valve 10 has essentially slowed or stopped the flow rate to the full extent that it is able based on its construction and the dimensions of the vanes 22 and 48 of the sections.

The figures show the vanes in different configurations, and the handle extending outwardly for easy changing of the flow rate.

The valve of the invention may be used in many different contexts and applications, in any situation where fluid flow rate may need to be adjusted from one job to another, or even within a particular job. The adjustment can be manual as shown, or it may be electronically controlled by utilizing suitable strategically placed sensors coupled with a motor so that the flow rate can be adjusted in real time based on the needs of the moment and any fluctuations and changes in external conditions, such as temperature, pressure, amount of fluid required in a given operation, ability to process fluid flowing through the valve 10 to name just a few possibilities although there may be many other factors that can be considered and taken into account. Control may be manually effected, or operated by a motor and electronic control assembly which receives data from the sensor(s) and controls flow rates automatically depending upon the sensed conditions, as appropriate.

Furthermore, while the invention as illustrated shows vanes or plates which are circular and have alternating vane and space construction, other forms of the invention may also be used. The vanes or plates may be other than circular, such as rectangular or square, and which slide relative to each other to provide fluid flow openings or closings, to modulate flow. The vanes or plates may also be of different shapes to each other. The openings or spaces in one or more of the vanes or plates may be circular holes, slots, other shaped holes and the like, as long as the objective of the valve may be accomplished, namely, moving the vanes relative to each other in order to open conduits or close conduits to control fluid flow through the valve.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A flow control device comprising:
a first component having a plurality of plates with open spaces,
a second component having a plurality of plates with open spaces therebetween,
wherein the first component and the second component are movable relative to each other between a first position wherein the plates and the open spaces of the first and second components substantially correspond with each other to permit fluid flow and a second position wherein the plates of the first component substantially overlie the open spaces of the second component to reduce or prevent fluid flow.

2. The flow control device as claimed in claim 1 wherein the movement between the first and the second components are effected incrementally between the first position and the second position so that the fluid flow can be finely adjusted according to the needs and context of the location and use of the flow control device.

3. The flow control device as claimed in claim 1 further comprising a housing for the first component and the second component, the second component being movably connected within the housing such that the respective plates and open spaces thereof may be positioned within the housing relative to plates and open spaces of the first component.

4. The flow control device as claimed in claim 1 wherein the first component and the second component are of circular shape, each having a center connection point and pivot point by means of which the first component is connected to the second component, and an outer circumferential rim.

5. The flow control device as claimed in claim 4 wherein the plates on each of the first component and the second component are in the form of alternating vanes and spaces between the vanes.

6. The flow control device as claimed in claim 5 wherein the vanes of both the first component and the second component are radial, extending from at or near the center connection point to at or near the outer circumferential rim of the first and second component respectively.

7. The flow control device as claimed in claim 6 wherein vanes of both of the first component and the second component taper from a narrower dimension near the center connection, to a wider dimension as they radiate out toward the outer circumferential rim.

8. The flow control device as claimed in claim 3 wherein the second component has a handle which extends to the outside of the housing to permit rotation of the second component in incremental distances so that flow control valve of the invention can be adjusted and modulated whether in operation or when not operating.

9. The flow control device as claimed in claim 8 further comprising a locking mechanism for releasably fixing the handle at a specific selected point to prevent movement during operation.

10. The flow control device as claimed in claim 1 wherein movement of the first component or the second component is manual.

11. The flow control device as claimed in claim 1 wherein movement of the first component or second component is performed by a motor.

12. The flow control device as claimed in claim 1 further comprising sensors for sensing selected conditions so that adjustment of the flow control valve is monitored and modulated on a real time basis.

13. The flow control device as claimed in claim 1 wherein the flow control device adjusts flow rate of liquid or gas, or a combination thereof.

14. A flow control device comprising:
a housing having an inlet and an outlet;
an inlet conduit connected to the inlet of the housing and through which fluid flows;
an outlet conduit connected to the outlet of the housing and through which fluid flows;
a fixed plate in the housing, the fixed plate having alternating vanes and spaces between the vanes;
a movable plate in the housing, the movable plate having alternating vanes and spaces between the vanes;
wherein the movable plate is movable relative to the fixed plate between a first position where the vanes and the spaces of the movable plate substantially correspond with the vanes and open spaces of the fixed plate to permit fluid flow, and a second position where the vanes and spaces of the movable plate substantially overlie the vanes and spaces of the fixed plate to reduce or prevent fluid flow.

15. The flow control device as claimed in claim 14 further comprising a handle formed on the movable plate, the handle extending to the outside of the housing so that the position of the movable plate can be adjusted by movement of the handle to vary flow rate.

16. The flow control device as claimed in claim 14 wherein the fixed plate is circular with outwardly radiating vanes increasing in width.

17. The flow control device as claimed in claim 14 wherein the movable plate is circular with outwardly radiating vanes increasing in width.

18. The flow control valve device as claimed in claim 14 wherein the movement of the movable plate is effected by a motor.

19. The flow control device as claimed in claim 18 further comprising sensors for sensing selected conditions and moving the movable plate in response to the sensed conditions.

20. A method of controlling flow rate through a valve comprising:
providing a housing having an inlet and an outlet;
connecting an inlet conduit at the inlet of the housing and through which fluid flows;
connecting an outlet conduit to the outlet of the housing and through which fluid flows;
locating a fixed plate in the housing, the fixed plate having alternating vanes and spaces between the vanes;
locating a movable plate in the housing, the movable plate having alternating vanes and spaces between the vanes;
moving the movable plate relative to the fixed plate between a first position where the vanes and the spaces of the movable plate substantially correspond with the vanes and open spaces of the fixed plate to permit fluid flow, and a second position where the vanes and spaces of the movable plate substantially overlie the vanes and spaces of the fixed plate to reduce or prevent fluid flow.
